(19) United States
(12) Patent Application Publication
(10) Pub. No.: US 2026/0069009 A1
(43) Pub. Date: Mar. 12, 2026

(54) Mobile Phone Case

(71) Applicant: Picosolutions Group Inc., Jersey City, NJ (US)

(72) Inventor: Michael Burghoffer, Jersey City, NJ (US)

(73) Assignee: Picosolutions Group Inc., Jersey City, NJ (US)

(21) Appl. No.: 18/827,761

(22) Filed: Sep. 8, 2024

(51) Int. Cl. A45C 11/00; A45C 13/00; H04B 1/3888

(52) U.S. Cl. CPC A45C 11/00; A45C 13/001; H04B 1/3888; A45C 11/002

(57) ABSTRACT

A mobile phone case comprising a shell made of a solid material layer with a back area featuring a geometrically-shaped opening. The opening is designed to receive a removable plate whose boundary conforms to the opening's shape. When the removable plate is inserted, it securely couples with the shell, ensuring a stable fit.

### TECHNICAL FIELD

This disclosure relates to mobile phone cases and, more specifically, to a mobile phone case with a geometrically-shaped opening for receiving a removable plate that may be selected from a set of plates. The disclosure is particularly applicable to protective cases that accommodate various materials and designs, ensuring both protection and personalization for the mobile phone user.

### BACKGROUND

As mobile phones have become an integral part of people's daily life, the demand for protective phone cases has increased.

### BRIEF DESCRIPTION OF THE DRAWINGS

The present disclosure is illustrated by way of example, and not by way of limitation, in the figures of the accompanying drawings.

FIG. 1 is an exploded perspective view of one embodiment of a mobile device case in accordance with one or more embodiments of the present disclosure.

FIG. 2A and FIG. 2B are front perspective view and back perspective views of the mobile phone case with a removable plate inserted into a geometrically-shaped opening.

FIG. 3 is an exploded perspective view of another embodiment of a mobile device case in accordance with one or more embodiments of the present disclosure.

### DETAILED DESCRIPTION

Traditional phone cases can provide basic protection but lack versatility and economic solutions for users to personalize their phone cases. Further, when a phone case is personalized (e.g., painted with colors or graphics), the user usually does not have the option to economically change the personalization. Embodiments of the disclosure provide a technical solution to overcome the above-identified and other deficiencies in personalization of phone cases.

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments may be used, and changes may be made without departing from the spirit and scope of the described embodiments.

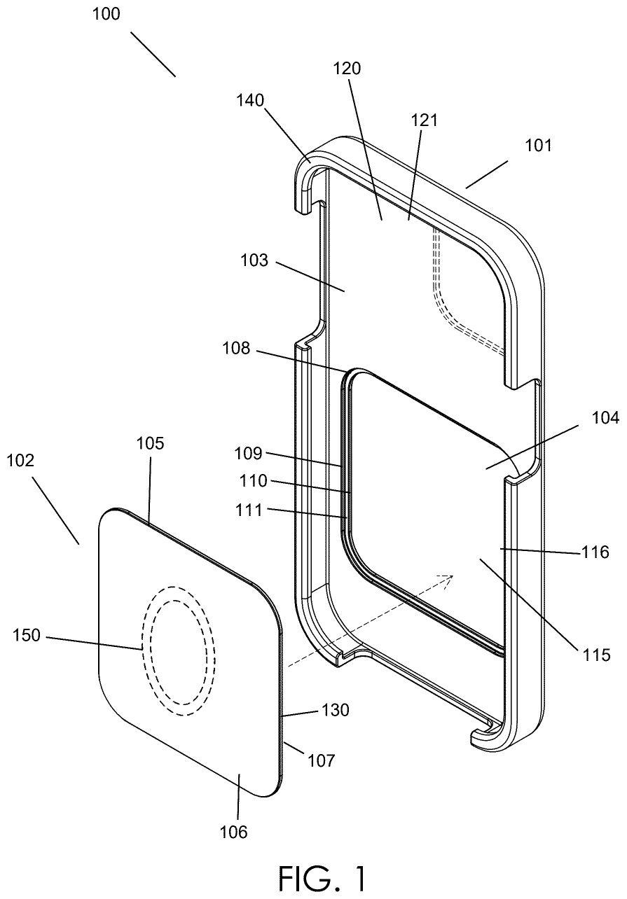

FIG. 1 is an exploded perspective view of a mobile phone case 100 in accordance with one or more embodiments of the present disclosure. Referring to FIG. 1, mobile phone case 100 may include a shell 101 with an opening 104 and a removable back plate 102 that may be removably inserted into opening 104 during use of mobile phone case 100. The mobile phone case 100 may provide protection against for at least a portion of an encased mobile phone from damage due to impacts, drops, scratches, and the like. In some embodiments, the mobile phone encased in mobile phone case 100 can be an iPhone® from Apple, Inc., an Android phone, or any type of suitable mobile phones.

As shown in FIG. 1, the mobile phone case 100 includes shell 101 configured to encase a mobile phone (not shown). Shell 101 can be made from a sheet of solid material (e.g., metal, plastic) using a manufacture process (e.g., 3D printing, injection molding, thermoforming etc.). Shell 101 includes a back area 103 with an opening 104 that is defined by a certain geometric shape (e.g., square with round corners) for receiving a removable plate 102 that has a shape matching opening 104. In some embodiments, the shape of the geometrically-shaped opening 104 can be one of several distinct forms, including a round-cornered square, a round-cornered rectangular, circular, or a polygonal or curved shape. The geometrically-shaped opening allows the phone case to accommodate different plates that each may be tailored to a particular personalization (e.g., different graphic patterns).

As shown in FIG. 1, removable plate 102 may be defined by a boundary 105 that conforms to geometrically-shaped opening 104, ensuring a secure coupling with shell 101 when inserted into geometrically-shaped opening 104.

As shown in FIG. 1, geometrically-shaped opening 104 can be a through-hole extending through the layer of the shell from an interior surface 120 to an exterior surface 121. In use, interior surface 120 may be in touch with a back surface of the mobile phone when the mobile phone is encased in shell 101.

As shown in FIG. 1, the opening 104 extends through the layer of the shell, forming two opening areas. A first opening area 115 is defined by geometrically-shaped opening 104 and interior surface 120, and a second opening area 116 is defined by geometrically-shaped opening 104 and exterior surface 121. The first opening area 115, which is adjacent to the interior surface 120, is larger than the second opening area 116, which is adjacent to the exterior surface 121, thus forming a tiered side wall 108 surrounding opening 104. Correspondingly, plate 102 may also include a tiered side wall 130 that the tiered side wall 108 surrounding 104. This design feature ensures that when inserted into geometrically-shaped opening 104, removable plate 102 first fits into the larger opening area 115, allowing for easier alignment and insertion and a tight coupling between the sides walls of plate 102 and opening 104 by a physical force (e.g., a frictional force between the side wall surfaces). As plate 102 is pushed further into opening 104, it transitions into the smaller second opening area 116, creating a tighter and more secure fit. In one embodiment, plate 102 fully covers opening 104. In another alternative embodiment, plate 102 may cover less than full of opening 104. The difference in the sizes of the opening areas creates a stepped or tiered effect, forming a barrier that prevents plate 102 from passing all the way through the opening 104. Additionally, this configuration provides a seamless and flush appearance on the exterior surface of the shell, as the plate aligns precisely with the shell's outer surface.

As shown in FIG. 1, geometrically-shaped opening 104 is surrounded by a tiered sidewall 108 which includes a first tier 110 close to exterior surface 121 and a second tier 109 close to interior surface 120. An intersection of first tier 110 and second tier 109 forms a groove 111 that accommodates the removable plate 102 when it is inserted, preventing plate 102 from passing through geometrically-shaped opening 104.

As shown in FIG. 1, removable plate 102 includes a first surface 106 and a second surface 107 substantially parallel to the first surface 106. The distance the two surfaces 106 and 107 defines the overall thickness of the plate. Further, removable plate 102 is surrounded by a tiered sidewall 130, and wherein when removable plate 102 is inserted into geometrically-shaped opening 104, tiered sidewall 130 fits into groove 111 formed by the intersection of first tier 110 and second tier 109. This design ensures that the plate is securely held in place, preventing it from shifting or falling out during regular use. The tiered sidewall and groove mechanism provide a snug and stable fit, enhancing the overall structural integrity of the mobile phone case.

As shown in FIG. 1, shell 101 further includes a plurality of bounding engagement members 140 that serve to cover at least a portion of the sides of the mobile phone, providing protection and stability when shell 101 encases a mobile phone. Engagement members 140 extend along the edges of shell 101 and overlap at least a portion of a front surface of the mobile phone and prevent the mobile phone from falling out of shell 101. Furthermore, engagement members 140 extend inward to interior surface 120 of shell 101, ensuring a snug and secure fit around the mobile phone. The space surrounded by engagement members 140 defines an opening that provides visibility of, and touch access to, the screen of the mobile phone. A direction toward the center of shell 101 from any of the sides is referred to as “inward” and a direction away from the case center from any of the sides is referred to as “outward.”

In one embodiment, geometrically-shaped opening 104 covers a center of the back area 103. In another embodiment, the geometrically-shaped opening is located centrally along the vertical axis of the exterior surface of the shell. In another embodiment, the geometrically-shaped opening is located in the lower quadrant of the exterior surface of the shell.

In one embodiment, the removable plate 102 may be embedded with a metal ring 150 in its structure. This metal ring 150 is strategically embedded in the plate 102, ensuring that the case 100 is fully compatible with magnetic technologies used in mobile phones such as MagSafe for iPhones or Qi Wireless for Android phones. The inclusion of this metal ring 150 allows the phone case to interact seamlessly with various magnetic accessories, such as wallets, stands, and wireless chargers. As shown in FIG. 1, the metal ring 150 may be positioned within the central area of the back plate, aligned with the mobile phone's internal magnetic ring when the plate 102 is inserted into the geometrically-shaped opening 104 of the shell 101. This ensures that the magnetic connection between the mobile phone and magnetic accessories remains strong and reliable, even with the phone case in place. By integrating magnetic compatibility, the mobile phone case offers a more versatile user experience. Users can efficiently attach magnetic-compatible accessories to the mobile phone case without the need for additional adhesive or mechanical attachments. Additionally, the mobile phone case allows for wireless charging through the magnetic technology, ensuring that the mobile phone can be charged conveniently and efficiently without removing the case. This embodiment enhances the functionality of the phone case, making it not only a protective accessory but also a versatile tool that supports modern, magnetically-attached accessories and wireless charging, thereby offering users greater convenience and flexibility in their everyday use.

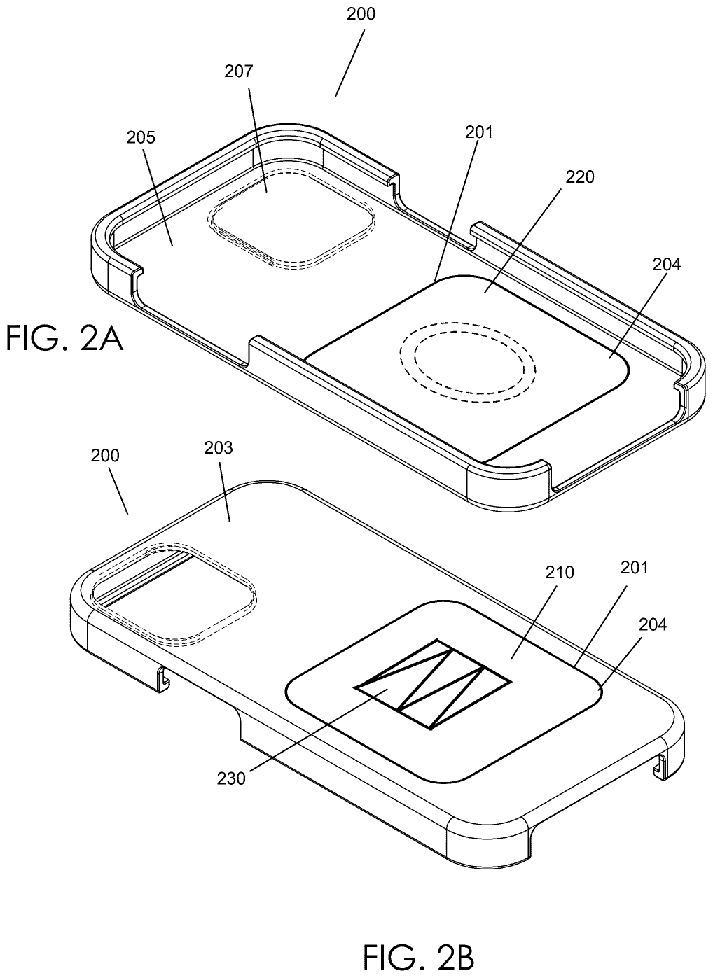

FIG. 2A and FIG. 2B show a front perspective view and a back perspective view of a mobile phone case 200 with a removable plate 201 inserted into a geometrically-shaped opening 204. As shown in FIG. 2A and FIG. 2B, removable plate 201 includes a first surface 210 and a second surface 220 that together define a removable plate area delimited by the boundary of removable plate 201. As shown in FIG. 2B, when removable plate 201 is inserted into geometrically-shaped opening 204, first surface 210 forms a substantially flat surface with an exterior surface 203 of the back area of the shell. As shown in FIG. 2A, when removable plate 201 is inserted into geometrically-shaped opening 204, second surface 220 forms a substantially flat surface with an interior surface 205 of the back area of the shell. When removable plate 201 is securely coupled with the shell, it completely fills geometrically-shaped opening 204.

In one embodiment, as shown in FIG. 2B, first surface 210 features a graphic display 230. This graphic display can vary widely in design, encompassing designs from color patterns and textures to images, logos, and artwork. The graphic display provides an opportunity for personalization, allowing users to customize their mobile phone case with designs that reflect their individual style or brand identity. The graphic display on the removable plate may be achieved through high-quality printing techniques that are resistant to wear and tear.

In one embodiment, as shown in FIG. 2A, the back area of the shell further includes a second opening 207 configured to align with and expose at least one of a camera, a flashlight, or a microphone. The dimensions and location of opening 207 match the specific layout of the mobile phone's features, ensuring full functionality without the need to remove the phone from the case. Moreover, the second opening can be shaped and sized to accommodate various phone models, allowing for compatibility with multiple devices.

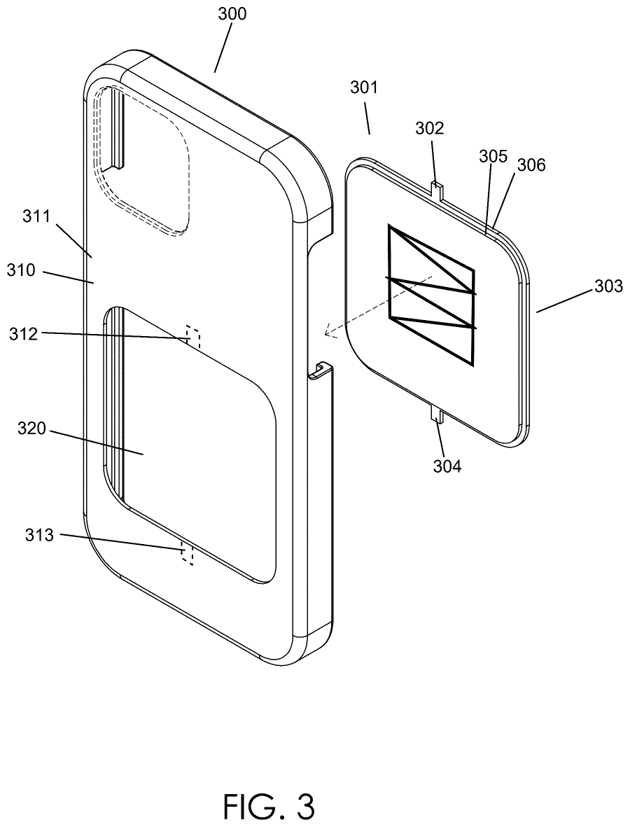

In one embodiment, as shown in FIG. 3, removable plate 301 designed to fit into the geometrically-shaped opening 320 of the mobile phone case 300 may include tiered sidewalls 303 may be in contact with the interior sidewalls of opening 320, ensuring a secure and snug coupling of plate 301 with the mobile phone case 300. The tiered sidewall 303 includes an outer tier 305 that is positioned closer to the exterior surface 310 of the phone case 300 when plate 301 is fully inserted and an inner tier 306 that is positioned closer to the interior surface 311 of the phone case 300 when plate 301 is inserted. The inner tier 306 is less recessed than the outer tier 305.

To further secure the coupling between plate 301 and the mobile phone case 300, plate 301 may further include one or more notches (e.g., notches 302 and 304 positioned centrally along two opposite edges of plate 301). In one embodiment, notches 302 and 304 are integrated into the inner tier 306 of the sidewall 303. The top notch 302 extends from the midpoint of the upper edge of plate 301, while the bottom notch 304 extends from the midpoint of the lower edge. Notches 302 and 304 align with corresponding slots 312, 313 within the geometrically-shaped opening 320 of the mobile phone case 300. When plate 301 is inserted into the geometrically-shaped opening 320, notches 302 and 304 on the tiered sidewall 303 may fit precisely into these slots 312, 313, locking the plate 301 in place and preventing lateral and rotational movements of plate 301 or accidental dislodgement. This design not only secures plate 301 within the mobile phone case 300 but also maintains the structural integrity and aesthetic continuity of the phone case, ensuring that plate 301 remains flush with the mobile phone case's exterior surface 310.

In one embodiment, the shell and the removable plate can be made from a variety of solid materials, including plastic, metal, wood, or leather. These materials provide users with options for different aesthetic and functional properties. For example, a plastic shell offers lightweight protection and a variety of color choices. A plastic plate can be easily customized with different colors and designs, while a metal plate adds a premium feel and durability. Wooden material offers a unique, eco-friendly look with various textures, and leather shells provide a classic, sophisticated appearance with a comfortable grip.

In one embodiment, a mobile phone case kit includes a mobile phone case with a geometrically-shaped opening, along with a plurality of removable plates that each have a substantially identical shape but different displays, allowing them to be interchangeably inserted into the opening. This interchangeable design allows users to easily customize their phone case by switching between plates with different graphic designs, colors, or textures based on the user's preferences over time.

In various embodiments, the mobile phone case can include accessory apertures, which can be positioned on any surface of the case. These apertures allow access to the features of the smart device, such as lighting, earphone jacks, power connectors, volume controls, power buttons, and other combinations of these elements.

In one embodiment, the geometrically-shaped opening may be designed to receive the removable plate through coupling based on frictional force between surfaces. The plate, which has corresponding tiered sidewalls, fits into the groove, creating a friction fit that securely holds the plate in place. When the plate is inserted, the contact surfaces of the plate and the shell's opening exert force against each other, creating resistance due to the friction between the surfaces. This resistance is strong enough to hold the plate securely in place, preventing it from shifting or dislodging during regular use, and is also easy to remove and replace with another plat. The surfaces of the sidewalls may be textured or coated with a material that increases friction, further improving the grip and stability.

In one embodiment, the geometrically-shaped opening may be designed to receive a removable plate through magnetic coupling. The magnets in the shell may be placed around the perimeter of the geometrically-shaped opening. The removable plate may contain corresponding magnets embedded along its edges. The magnets in the removable plate may be aligned to match the positioning of the magnets in the shell, ensuring a secure and even attachment when the plate is placed in the opening. The magnets in the shell may be embedded beneath the surface of the shell material, creating a magnetic field designed to attract the corresponding magnets in the plate. The magnetic force is strong enough to prevent the plate from shifting or falling out during normal use but allows for removal when needed. The magnetic coupling mechanism allows for easy insertion and removal of the plate, facilitating customization. The magnetic force ensures that the plate remains securely in place during regular use.

The mobile phone case with a removable and interchangeable plate can be used in both personal customization and commercial advertising. In examples, the ability to interchange plates on a mobile phone case allows users to switch between different designs, matching their case to their outfit, mood, or specific events. As another example, the interchangeable plate feature provides an effective advertising platform. For instance, companies can design plates featuring their logos, slogans, or product images. This form of advertising is impactful because it ensures that the brand is seen frequently, given how often people use and look at their phones. As another example, the interchangeable plate feature may also provide an effective way to event-specific promotions. Brands may create limited-edition plates for events such as sports games, concerts, festivals, and trade shows. Attendees can receive these plates as part of their event experience. Furthermore, the removable plate feature may allow for collaborative marketing campaigns. Multiple brands may partner to create co-branded plates, which can be particularly appealing for special promotions or joint ventures.

The design is also aligned with sustainability and cost-effectiveness. Instead of producing an entirely new phone case for each new design or promotion, only the plates need to be manufactured and distributed. This approach reduces material waste and production costs, making it an eco-friendly and economical option for both consumers and businesses.

The term mobile phone as used herein includes, but is not limited to, mobile phones, cellular phones, smartphones, tablets, tablet computers, phablets, iPhones, iPads, iOS devices, Android devices, Windows Mobile devices, Windows devices, Microsoft Surface devices, Blackberry devices, and the like.

Language: In the foregoing descriptions, numerous details are set forth. It will be apparent, however, to one of ordinary skill in the art having the benefit of this disclosure, that the present disclosure may be practiced without all of these specific details. In some instances, well-known structures and devices are shown in block diagram form, rather than in detail, in order to avoid obscuring the present disclosure.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.”

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A mobile phone case, comprising:
a shell for encasing a mobile phone, the shell comprising a layer of a solid material, the layer comprising a back area comprising a geometrically-shaped opening for receiving a removable plate, the removable plate comprising a boundary conforming with the geometrically-shaped opening, wherein the removable plate, when inserted into the geometrically-shaped opening, securely is coupled with the shell.

2. The case of claim 1, wherein the removable plate comprises a first surface and a second surface that define a removable plate area delimited by the boundary of the removable plate, and when the removable plate is inserted into the geometrically-shaped opening, the first surface of the removable plate forms a substantially flat surface with an exterior surface of the back area of the shell and the second surface of the removable plate forms a substantially flat surface with an interior surface of the back area of the shell.

3. The case of claim 2, wherein when the removable plate is securely coupled with the shell, the removable plate area completely or partially fills in the geometrically-shaped opening, and wherein the geometrically-shaped opening and the interior surface of the shell define a first opening area, the geometrically-shaped opening and the exterior surface of the shell define a second opening area, and the first opening area is greater than the second opening area.

4. The case of claim 2, wherein the geometrically-shaped opening extending through the layer of the shell from the interior surface of the shell to the exterior surface of the shell is surrounded by a tiered sidewall, and wherein the tiered sidewall comprises a first tier close to the exterior surface of the shell and a second tier close to the interior surface of the shell, and an intersection of the first tier and the second tier forms a groove that when the removable plate is inserted into the geometrically-shaped opening, accommodates and prevents the removable plate from passing through the geometrically-shaped opening.

5. The case of claim 4, wherein the first surface and the second surface of the removable plate are substantially parallel to each other and together define a thickness of the removable plate that is surrounded by a tiered sidewall, and wherein when the removable plate is inserted into geometrically-shaped opening, the tiered sidewall of the removable plate fits into the groove.

6. The case of claim 4, wherein the second tier of the tiered sidewall of the geometrically-shaped opening is arranged with one or more slots, and the removable plate is arranged with one or more notches corresponding to the one or more slots, and wherein when the removable plate is inserted into the geometrically-shaped opening, the one or more notches are fittingly inserted into the corresponding one or more slots.

7. The case of claim 2, wherein the first surface of the removable plate comprises a graphic display.

8. The case of claim 1, wherein the interior surface of the shell is in touch with a back surface of the mobile phone when the mobile phone is placed within the shell.

9. The case of claim 1, wherein the shell further comprises a plurality of bounding engagement members for covering at least a portion of sides of the mobile phone, the plurality of bounding engagement members encasing at least a portion of a front surface of the mobile phone.

10. The case of claim 1, wherein the back area of the shell further comprises a second opening configured to align with and expose at least one of a camera, a flashlight, or a microphone.

11. The case of claim 1, wherein the solid material forming the shell comprises at least one of a plastic, a metal, wood, or a leather, and wherein the removable plate comprises at least one of a plastic, a metal, wood, or a leather.

12. The case of claim 1, wherein the geometrically-shaped opening covers a center of the back area of the shell.

13. The case of claim 1, wherein the geometrically-shaped opening is located centrally along the vertical axis and in the lower quadrant of the exterior surface of the shell.

14. The case of claim 1, wherein the shape of the geometrically-shaped opening and is one of a round-cornered square, a round-cornered rectangular, circular, or a polygonal or curved shape.

15. The case of claim 1, wherein the removable plate is embedded therein with a metal ring that is compatible with a magnetic technology standard.

16. A mobile phone case kit, comprising the mobile phone case of claim 1, and a plurality of removable plates that each has a substantially identical shape and is interchangeably insertable into the geometrically-shaped opening of the shell.

17. The kit of claim 16, wherein at least two of the plurality of removable plates have different graphic designs on their exterior surfaces.
